(19) United States
(12) Patent Application Publication
(10) Pub. No.: US 2024/0429564 A1
(43) Pub. Date: Dec. 26, 2024

(54) MID-PACK SERVICEABLE BUSBAR

(71) Applicant: Rivian IP Holdings, LLC, Irvine, CA (US)

(72) Inventors: Jonathan Verghese, Costa Mesa, CA (US); Suraj Shroff, Sunnyvale, CA (US)

(21) Appl. No.: 18/341,322

(22) Filed: Jun. 26, 2023

(51) Int. Cl. H01M 50/503; H01M 50/507

(52) U.S. Cl. CPC H01M 50/503; H01M 50/507

(57) ABSTRACT

The present solution is directed to systems and method for electrically disconnecting at least a portion of a battery pack using a busbar. The present solution can include a busbar to electrically couple with a battery pack between two groups of battery cells of the battery pack. The busbar can dispose at an opening of a housing of the battery pack. The busbar can be exposed by an access cover. The busbar can include a jumper connector electrically coupling one body of the busbar electrically coupled with a first group of battery cells of the battery pack with another body of the busbar electrically coupled with a second group of battery cells of the battery pack. The jumper connector can be accessible via the opening under the access cover to allow electrical decoupling of the first or second group of battery cells.

Electric vehicles (EVs) can be powered using batteries storing energy that can be used to power and move the vehicle. The batteries can include different components facilitating energy storage and distribution.

### SUMMARY

The present solution provides an in-vehicle serviceable busbar that can be used to divide the voltage of a battery pack (e.g., into two halves of about 50% of the battery pack voltage), allowing a convenient in-vehicle service, maintenance, and repair at a reduced voltage level. The busbar can allow a service technician to disconnect the high voltage within a battery pack from the rest of the vehicle, without removing the battery pack from the vehicle. The busbar can also allow disconnecting of one battery pack from the high voltage distribution box of the EV, or from another battery pack, in order to allow for servicing of one of the battery packs within or outside of the vehicle, as well as allowing for cross-compatible battery packs to be used in the same vehicle. The busbar can include a first busbar electrically coupled with a first portion of the battery pack (e.g., or a first battery pack) and a second busbar to couple with a second portion of the battery pack (e.g., or a second battery pack). Each of the first and second busbars can include a respective of a first and second jumpers that are bend (e.g., at a 90% angle, arcing downward) relative to a body of each of the respective one of the first and second busbars. A connector jumper can be used to electrically couple the first and second jumpers. To disconnect the busbar, the connection jumper can be removed, thereby uncoupling the first and second jumpers and electrically separating the first portion of the battery pack (or the first battery pack) from the second portion of the battery pack (or the second battery pack). A cover made from electrically insulating material can be used to insulate, shield, or cover the connector jumper, the first and the second jumpers and the bodies of the first and second busbars.

At least one aspect is directed to a system. The system can include a busbar to electrically couple with a battery pack between two groups of battery cells of the battery pack. The busbar can dispose at an opening of a housing of the battery pack. The busbar can be exposed by an access cover.

At least one aspect is directed to a method for electrically decoupling at least a portion of a battery pack. The method can include electrically coupling a busbar with two groups of battery cells of a battery pack. The method can include disposing the busbar at an opening of a housing of the battery pack. The method can include exposing the busbar for access by an access cover.

At least one aspect is directed to a battery system of an electric vehicle. The battery system can include a busbar to electrically couple with a battery pack between two groups of battery cells of the battery pack. The busbar can dispose at an opening of a housing of the battery pack. The busbar can be exposed by an access cover. The battery system can include a jumper connector to electrically couple a first body of the busbar with the second body of the busbar, the jumper connector removable via the access cover on an end plate of the housing to cause a first group of the two groups of battery cells electrically coupled with the first body to electrically decouple from a second group of the two groups of the battery cells electrically coupled with the second body.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle.

FIG. 2A depicts an example of a battery pack.

FIG. 2B depicts an example of a battery pack with battery subassemblies.

FIG. 2C depicts a cross sectional view of a battery cell.

FIG. 2D depicts a cross sectional view of a battery cell.

FIG. 2E depicts a cross sectional view of a battery cell.

FIG. 3 illustrates an example of a battery system including an access cover for accessing a busbar of the battery pack.

FIG. 4 illustrates an example of a battery system with a busbar for reducing the voltage of a battery pack.

FIG. 5 illustrates an example of a cross-sectional view of a busbar for reducing the voltage of the battery system.

FIG. 6 illustrates an example of an access opening for accessing the busbar for reducing the voltage of a battery pack.

FIG. 7 illustrates an example of a top view of the access opening and the busbar in a battery pack.

FIG. 8 illustrates a flow diagram of an example method for electrically decoupling at least a portion of a battery pack using a busbar.

### DETAILED DESCRIPTION

Following below are more detailed descriptions of various concepts related to, and implementations of, methods, apparatuses, and systems of electrically decoupling at least a portion of a battery pack using a busbar. The various concepts introduced above and discussed in greater detail below may be implemented in any of numerous ways.

This disclosure is generally directed to a system including an in-vehicle serviceable busbar of a battery pack. The busbar can be positioned in a mid-section, an intermediate node or a middle of a battery pack (e.g., a battery pack subassembly) and split the voltage of the battery pack by approximately 50% (e.g., between two groups of battery cells). For example, from a standpoint of electrical architecture, the busbar 310 can be deployed and connected with battery cells 120 of the battery pack 110, such that it provides serviceability by for example halving voltage of the battery pack 110 at mid-pack (e.g., providing two halves of the voltage of the pack). The busbar allows for convenient in-vehicle service, maintenance, and repair of the battery pack and any components connected thereto. For example, the system described herein allows disconnecting of the high volt within battery pack from the rest of the vehicle from outside of the battery pack, while battery pack remains within the vehicle. Accordingly, a service technician can service and replace components within battery pack and from the rest of the vehicle, while the battery pack remains within the vehicle. In addition, a battery pack can include two battery packs, one serviceable when it is outside of the vehicle and another serviceable when it remains within the vehicle, the system described herein allow the busbar to be disconnected while both packs are within the vehicle, thus allowing for cross-compatible battery packs used in the same vehicle.

The busbar connects the battery pack (e.g., the battery cells therein) to the various components such as a high voltage distribution box (HVDB), fuses, current sensors, contactors, battery management system (BMS), battery voltage temperature monitor (BVT), and so on. The busbar can be electrically coupled to a Current Collector Assembly (CCA) busbar which connects to the terminals of the battery cells. Such components can be serviced, maintained, checked, monitored, or evaluated after disconnecting the busbar in the manner described. For example, after disconnecting the busbar, the voltage at the HVDB is 0 V, and the current sensed by the current sensors is 0 amps.

The busbar can include a first busbar to couple with a first portion of the battery pack and a second busbar to couple with a second portion of the battery pack. Each of the first and second busbars includes a respective of a first and second jumpers that are bend (e.g., at a 90% angle, arcing downward, and so on) relative to a body of each of the respective one of the first and second busbars. The busbar can include a connection jumper to couple the first and second jumpers. To disconnect the busbar (e.g., to electrically decouple the high voltage within the battery pack from the high voltage distribution box), the connection jumper can be removed, thus uncoupling the first and second jumpers. A cover made of insulation material (e.g., plastic material) can be provided to cover the bodies of the first and second busbars. In one aspect, the present solution can include a busbar that is serviceable from outside of the battery pack that can be configured as a modular add on to the module or subassembly within the battery pack. This can allow, for example, two variants of a battery pack to be made with the same module or subassembly. One variant can include the serviceable busbar subassembly and thus allow for service accessible via the busbar while the battery pack remains within the vehicle, while another battery pack variant may, for example, not include this subassembly. The pack variant can then be chosen based on the configuration of the vehicle. The present solution can be directed to the ‘mid-pack’ electrical architecture, in which the busbar can provide a serviceable feature at an intermediate node of the battery pack to reduce the voltage of the battery pack, such that the maximum voltage present in the system is reduced to facilitate serviceability.

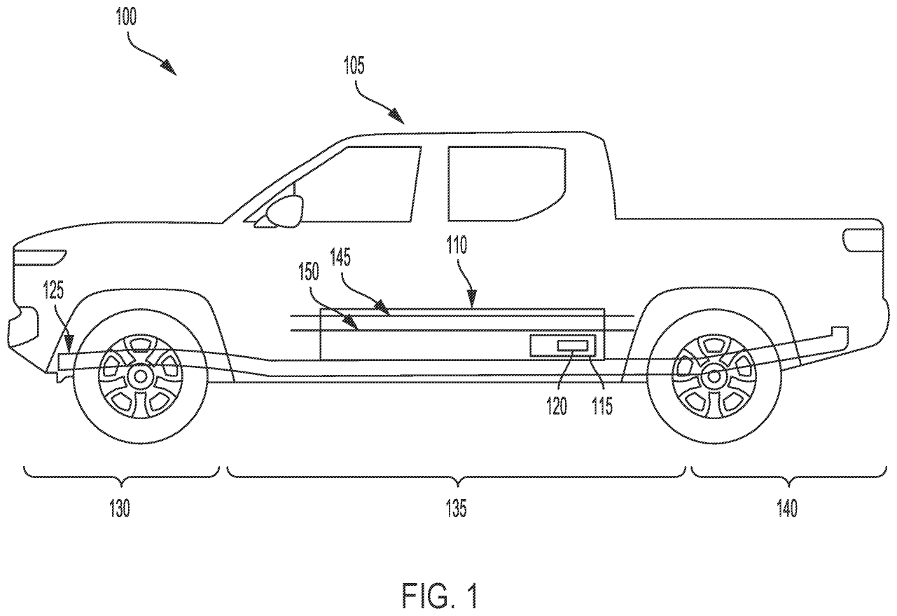

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery subassemblies 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery subassemblies 115, or the battery cells 120 with other electrical components of the electric vehicle 105 to provide electrical power to various systems or components of the electric vehicle 105.

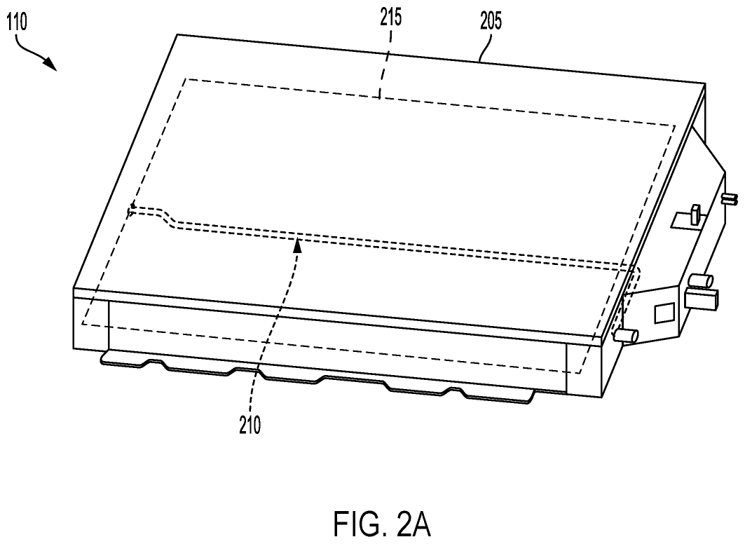

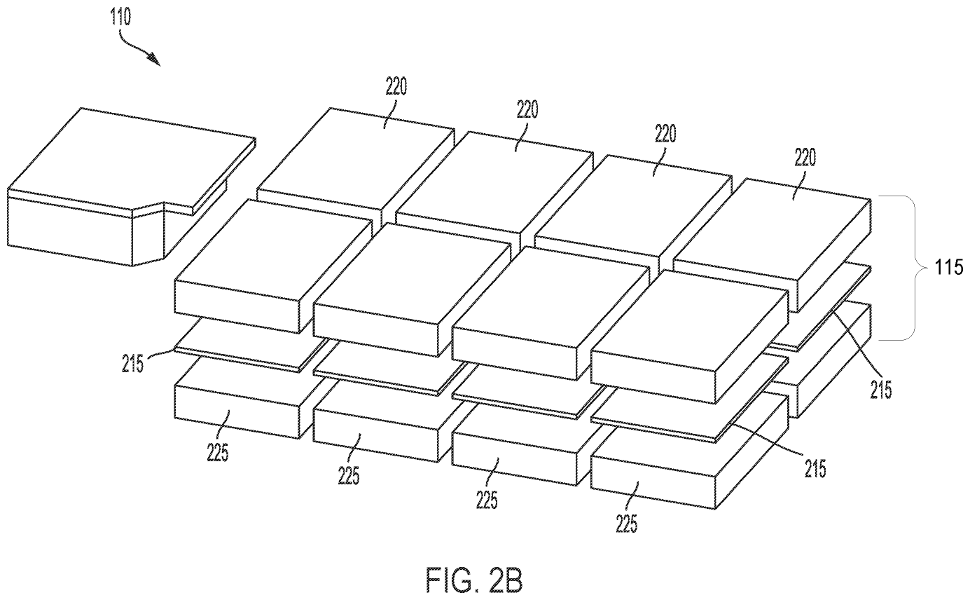

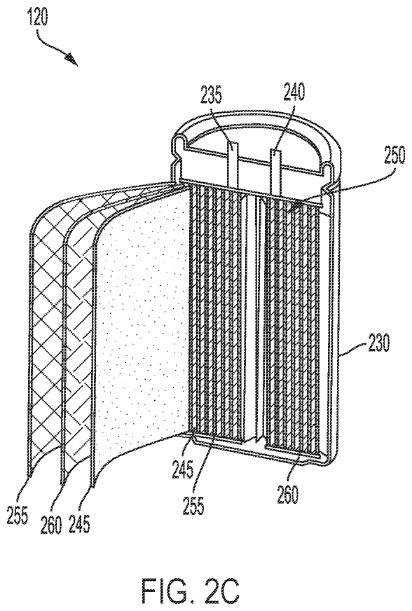

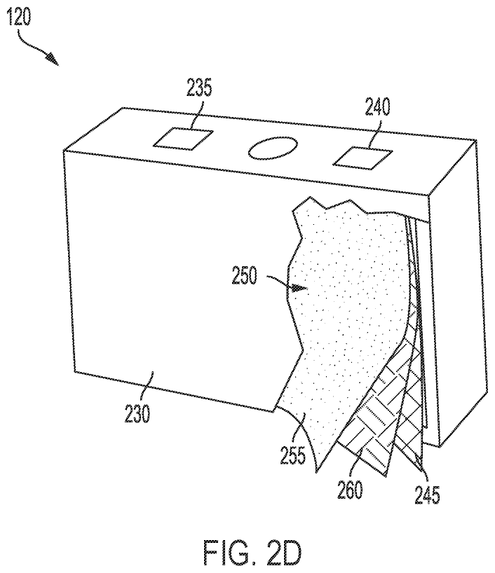

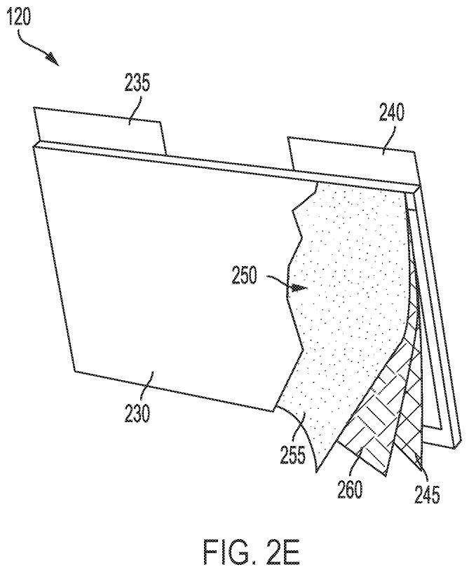

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery subassembly 115 or at least one battery cell 120, as well as other battery pack components. The battery subassembly 115 can be or can include one or more groups of prismatic cells, cylindrical cells, pouch cells, or other form factors of battery cells 120. The housing 205 can include a shield on the bottom or underneath the battery subassembly 115 to protect the battery subassembly 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery subassembly 115. At least one cooling line 210 can be coupled with, part of, or independent from the thermal component 215.

FIG. 2B depicts example battery subassemblies 115, and FIGS. 2C, 2D and 2E depict an example cross sectional view of a battery cell 120. The battery subassemblies 115 can include at least one submodule. For example, the battery subassemblies 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery subassembly 115. The thermal component 215 can be disposed or thermally coupled between the top submodule 220 and the bottom submodule 225. One thermal component 215 can also be thermally coupled with more than one battery subassembly 115 (or more than two submodules 220, 225). The thermal components 215 shown adjacent to each other can be combined into a single thermal component 215 that spans the size of one or more submodules 220 or 225. The thermal component 215 can be positioned underneath submodule 220 and over submodule 225, in between submodules 220 and 225, on one or more sides of submodules 220, 225, among other possibilities. The thermal component 215 can be disposed in sidewalls, cross members, structural beams, among various other components of the battery pack, such as battery pack 110 described above. The battery submodules 220, 225 can collectively form one battery subassembly 115. In some examples each submodule 220, 225 can be considered as a complete battery subassembly 115, rather than a submodule.

The battery subassemblies 115 can each include a plurality of battery cells 120. The battery subassemblies 115 can be disposed within the housing 205 of the battery pack 110. The battery subassemblies 115 can include battery cells 120 that are cylindrical cells or prismatic cells, for example. The battery subassembly 115 can operate as a modular unit of battery cells 120. For example, a battery subassembly 115 can collect current or electrical power from the battery cells 120 that are included in the battery subassembly 115 and can provide the current or electrical power as output from the battery pack 110. The battery pack 110 can include any number of battery subassemblies 115. For example, the battery pack can have one, two, three, four, five, six, seven, eight, nine, ten, eleven, twelve or other number of battery subassemblies 115 disposed in the housing 205. It should also be noted that each battery subassembly 115 may include a top submodule 220 and a bottom submodule 225, possibly with a thermal component 215 in between the top submodule 220 and the bottom submodule 225. The battery pack 110 can include or define a plurality of areas for positioning of the battery subassembly 115 and/or cells 120. The battery subassemblies 115 can be square, rectangular, circular, triangular, symmetrical, or asymmetrical. In some examples, battery subassemblies 115 may be different shapes, such that some battery subassemblies 115 are rectangular but other battery subassemblies 115 are square shaped, among other possibilities. The battery subassembly 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery submodules 220 and 225. The battery cells 120 can be disposed in the battery pack 110 in a cell-to-pack configuration without submodules 220 and 225, among other possibilities.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N₂). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery subassemblies 115 or battery packs 110 to power components of the electric vehicle 105. The battery cell housing 230 can be disposed in the battery subassembly 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery pack may not include subassemblies (e.g., subassembly-free). For example, the battery pack can have a subassembly-free or cell-to-pack configuration where the battery cells are arranged directly into a battery pack without assembly into a subassembly.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also receive lithium ions during the discharging of the battery cell 120. Conversely, the cathode layer 255 can receive electrical current into the battery cell 120 and can output electrons during the charging of the battery cell 120. The cathode layer 255 can release lithium ions during the charging of the battery cell 120.

The battery cell 120 can include a layer 260 disposed within the cavity 250. The layer 260 can include a solid electrolyte layer. The layer 260 can include a separator wetted by a liquid electrolyte. The layer 260 can include a polymeric material. The layer 260 can include a polymer separator. The layer 260 can be arranged between the anode layer 245 and the cathode layer 255 to separate the anode layer 245 and the cathode layer 255. The polymer separator can physically separate the anode and cathode from a cell short circuit. A separator can be wetted with a liquid electrolyte. The liquid electrolyte can be diffused into the anode layer 245. The liquid electrolyte can be diffused into the cathode layer 255. The layer 260 can help transfer ions (e.g., Li⁺ ions) between the anode layer 245 and the cathode layer 255. The layer 260 can transfer Li⁺ cations from the anode layer 245 to the cathode layer 255 during the discharge operation of the battery cell 120. The layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example lithium iron phosphate (LFP), lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black. Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The layer 260 can include or be made of a liquid electrolyte material. For example, the layer 260 can be or include at least one layer of polymeric material (e.g., polypropylene, polyethylene, or other material) including pores that are wetted (e.g., saturated with, soaked with, receive, are filled with) a liquid electrolyte substance to enable ions to move between electrodes. The liquid electrolyte material can include a lithium salt dissolved in a solvent. The lithium salt for the liquid electrolyte material for the layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. Liquid electrolyte is not necessarily disposed near the layer 260, but the liquid electrolyte can fill the battery cells 120 in many different ways. The layer 260 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S−SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the layer 260 includes a liquid electrolyte material, the layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The layer 260 can include at least one additive. The additives can be or include vinylidene carbonate, fluoroethylene carbonate, ethyl propionate, methyl propionate, methyl acetate, ethyl acetate, or a mixture of any two or more thereof. The layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the layer 260 from greater than 0 M to about 1.5 M. Once disposed to the battery cell 120, liquid electrolyte can be present and touching battery subcomponents present within the battery cell 120. The battery subcomponents can include the cathode, the anode, the separator, the current collector, etc.

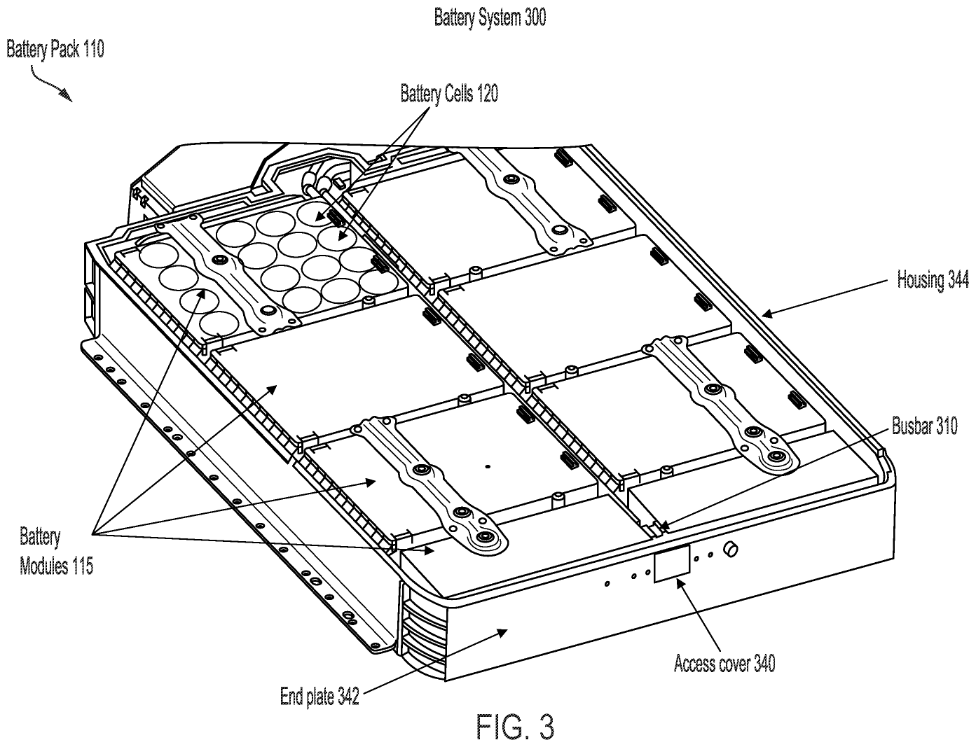

FIG. 3 depicts an example block diagram of an example battery system 300, also referred to as the system 300, having a battery pack 110 that includes an access cover 340 for accessing a busbar 310 for reducing the battery pack voltage. Battery system 300 can include one or more battery packs 110. Each battery pack 110 can include a housing 344. Battery pack 110 can include one or more battery subassemblies 115. Each of the battery subassemblies 115 can include one or more cells 120. In some embodiments, a battery pack 110 can include a plurality (e.g., a group) of battery cells 120.

Battery pack 110 can include an access cover 340. The access cover 340, can include any access member or a component protecting or exposing access to the busbar 310. Access cover 340 can be a part of the end plate 342, which can be a portion of the housing 344. Access cover 340 can provide access to the busbar 310 included beneath (e.g., on the other side of) the access cover 340, for maintenance or inspection. Access cover 340 can include an electrically insulative material (e.g., a plastic) to provide protection to the busbar 310 within the battery pack 110 from environmental elements, such as dust or moisture. Access cover 340 can allow a user (e.g., a maintenance technician or a mechanic) to access the busbar 310, troubleshoot issues, replace faulty parts, perform routine checks or disassemble a part of the busbar 310 to cause a voltage from the battery pack 110 to be reduced (e.g., into two or more portions of the battery pack 110).

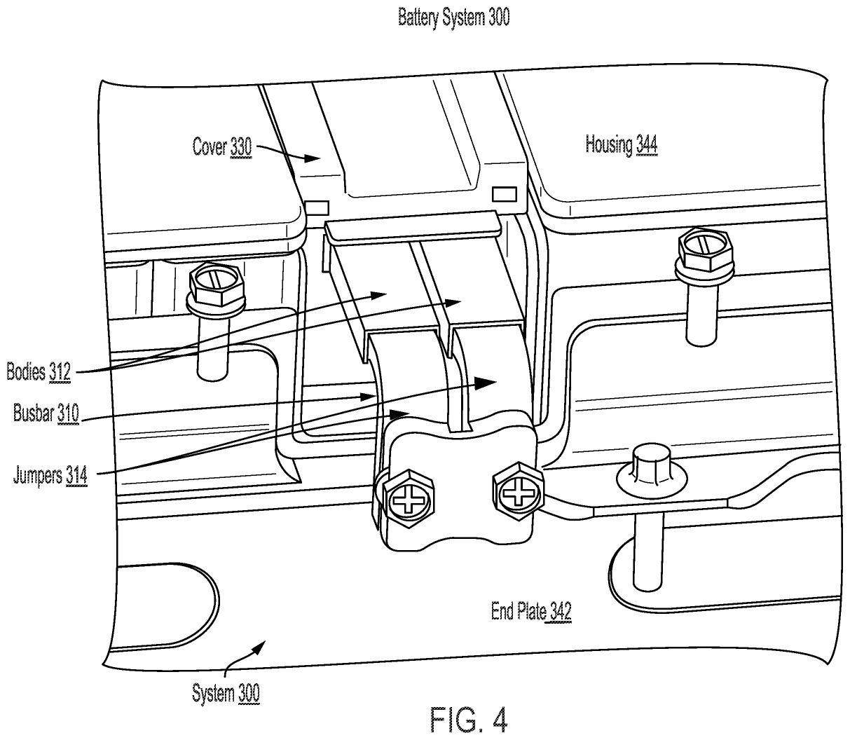

FIG. 4 illustrates an example of a battery system 300 having a busbar 310 for reducing the voltage of a battery pack 110. Busbar 310 can include multiple (e.g., two or more) bodies 312 which can be electrically coupled any number of battery cells 120, such as a group of battery cells 120 in one or more battery subassemblies 115. Each body 312 can be electrically coupled with a jumper 314. Each jumper 314 can be curved downward or otherwise shaped to interface with or be coupled with a jumper connector 318, also referred to as a mid-pack busbar 318. A jumper connector 318 (e.g., the mid-pack busbar) can electrically couple two or more jumpers 314 so that the bodies 312 of the busbar 310 are electrically coupled with each other. An access opening 350, which can be otherwise covered by access cover 340, can provide an access to a jumper connector 318, jumpers 314 and the bodies 312 of the busbar 310 to a user, such as a technician or a mechanic.

Busbar 310 can include any one or more electrically conductive components for electrically coupling or electrically decoupling groups of battery cells 120 of a battery pack 110. Busbar 310 can include one or more electrically conductive parts (e.g., busbar bodies 312, jumpers 314 and/or jumper connectors) for creating an electrical continuity different groups of battery cells 120 (e.g., one or more battery subassemblies 115). Busbar 310 can include electrically conductive components (e.g., metal components) interconnected with each other and allow for a sufficient amount of electrical conductivity so as to be used in high voltage and high current applications of an electric vehicle battery (e.g., about 150 to 200 kilowatt hours or about 50 to 70 amperes of current). Busbar 310 can be configured, deployed, or disposed to be accessible to users (e.g., mechanics or technicians) via an access opening 350. Busbar 310 can be configured or disposed to allow a user to electrically connect or disconnect or electrically couple or decouple two or more battery cells 120, groups of battery cells 120, two or more battery subassemblies 115, groups of battery subassemblies 115, two or more battery packs 110 or groups of battery packs 110.

The groups of battery cells 120 can be connected to each other in series, parallel or any combination of series and parallel configuration. A group of battery cells 120 can include any amount or ratio of battery cells 120 of a battery pack 110. For example, a group of battery cells 120 can include a half of all battery cells in a battery pack 110, a third of the battery cells 120 of the battery pack, a quarter of the battery cells, or any other ratio or proportion of battery cells 120 in the battery pack 110, such as ⅕, ⅙, 1/7, ⅛, 1/10, 1/12, 1/16, 1/20 or any other fraction. Each of the groups of battery cells 120 can be electrically coupled with at least one of the bodies 312 of the battery pack 110.

Body 312 can include any one or more electrically conductive parts or components for providing electrical continuity between the jumper 314 or a jumper connector 318 and one or more battery cells 120, battery subassemblies 115 or battery packs 110. Body 312 can include a metal component (e.g., a bar or a wire) electrically coupling battery cells 120, subassemblies 115 or packs 110 with a jumper connector 318. Body 312 can include a metal bar disposed between the jumper connector 318 at an end of the battery pack 110 and battery cells 120 or subassemblies 115 in the interior of the battery pack 110. Body 312 can be covered by an electrically insulative cover 330. Cover 330 can be a part of the housing 344 enclosing or providing an outer surface of the battery pack 110.

Bodies 312 of a busbar 310 can be routed through the battery pack 110 to any number of groups of battery cells 120. For example, busbar 310 can include a first component (e.g., a first body 312) coupled with a first half of the battery pack 110 (e.g., one or more battery subassemblies 115 with a group of battery cells 120) and a second component (e.g., a second body 312) coupled with a second half of the battery pack 110. For example, busbar 310 can include a first body 312 coupled with a first quarter of the battery pack 110 (e.g., one or more battery subassemblies 115 with a first group of battery cells 120), a second body 312 coupled with a second quarter of the battery pack 110, a third body 312 coupled with a third quarter of the battery pack 110 and a fourth body 312 coupled with a fourth quarter of the battery pack. Each of the bodies 312 can be electrically insulated from each other (e.g., via an air gap or electrically insulating material) and can be electrically coupled with each other only via the jumper connector 318.

Jumper 314 can include a component configured to connect, couple or interface with the jumper connector 318. Jumper 314 can include an end of a body 312. Jumper 314 can be bent at a 90-degree angle with respect to the remainder of the body 312 (e.g., a bar or a rod). Jumper 314 can be bent, shaped, curved or otherwise configured to provide a straight, lined up or otherwise equidistant ending surface for connecting with the jumper connector 318. Jumper 314 can be a portion of a body 312 or a component connected or coupled with the body 312. Jumper 314 can be shaped or formed to provide an electrical contact suitable for high current electric vehicle applications (e.g., up to 100 A of current).

Jumper connector 318, also referred to as a mid-pack busbar 318, can include any electrically conductive component for electrically shorting or coupling two or more bodies 312 of the busbar 310. For example, a jumper connector 318 can include a plate for connecting or coupling with a plurality of jumpers 314, each one of which is coupled with its own body 312, coupled with its own group of battery cells 120. Jumper connector 318 can include a flat surface plate, a curved surface plate or any component for receiving, attaching to, coupling with, or otherwise connecting to one or more jumpers 314 or bodies 312. Jumper connector 318 can include screw holes for allowing the jumper connector 318 to be screwed onto, or fastened with, a jumper 314 and/or body 312.

Housing 344 can include any structure or component for enclosing, covering, or protecting any portion of the battery pack 110. Housing 344 can include plates or covers on outer surface of the battery pack 110, such as an end plate 342. Housing 344 can include or be connected with electrically insulating components, such as covers 330 covering the top side of the bodies 312. End plate 342 can include a sheet or a plate of a material, such as metal or plastic, and can be used as a portion of a housing 344 on a side of a battery pack 110.

An access opening 350 can include any opening through a housing 344 (e.g., an end plate 342) to provide access for servicing the busbar 310. Access opening 350 can be covered by a removable access cover 340, which a user (e.g., technician or a mechanic) can move aside or remove to access a jumper connector 318 of the busbar 310. The user can remove the jumper connector 318 to electrically decouple the bodies 312 electrically coupled with their respective groups of battery cells 120, causing the voltage output from each of the disconnected groups of battery cells 120 to be reduced. For example, a user can unscrew the screws of the jumper connector 318 to decouple the jumper connector 318 from the jumpers 314 of the bodies 312. In doing so, the user can electrically separate groups of battery cells 120 coupled with the bodies 312. thereby reducing voltage and/or current output of the battery pack 110. This can be useful, for example, when a lower current and/or voltage output is desirable during the maintenance or repair of the battery pack 110.

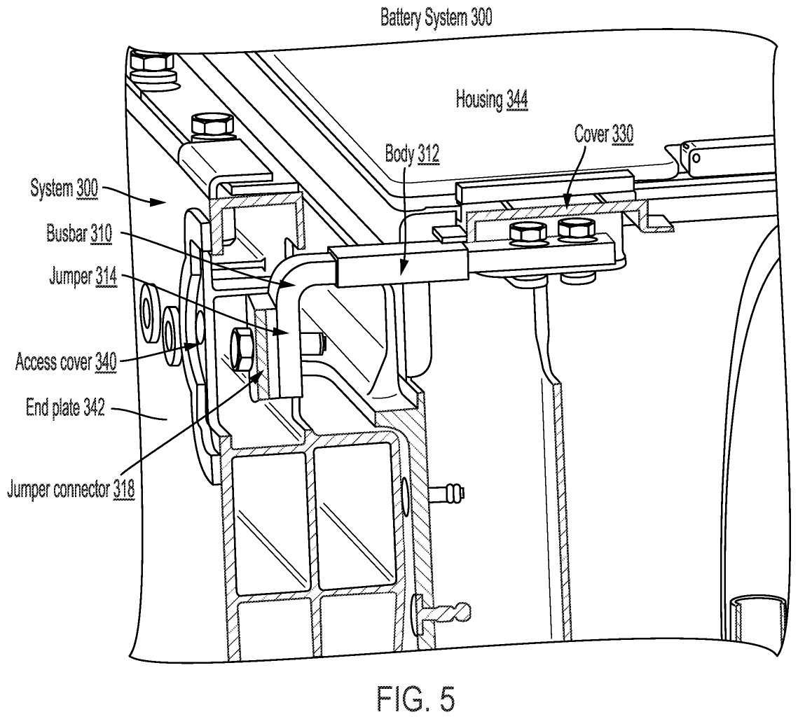

FIG. 5 illustrates an example of a cross-sectional view of a busbar 310 for reducing the voltage of the battery system 300. As shown in FIG. 5, battery system 300 can include a body 312 of the busbar 310 that can be coupled, on its interior end, with a battery subassembly 115 (e.g., or any other portion of a battery pack 110). The exterior end of the body 312 can include a jumper 314 that can be curved, bent, shaped, or formed downward to line up with the flat surface of the jumper connector 318. Covering the jumper connector 318 can be an access cover 340 that can be used to cover the access opening 350 in the end plate 342. Body 312 of the busbar 310 can be electrically coupled via fasteners (e.g., screws or clips) to any number of battery cells 120 within one or more battery subassemblies 115 or battery packs that can be electrically connected to each other and to the body 312.

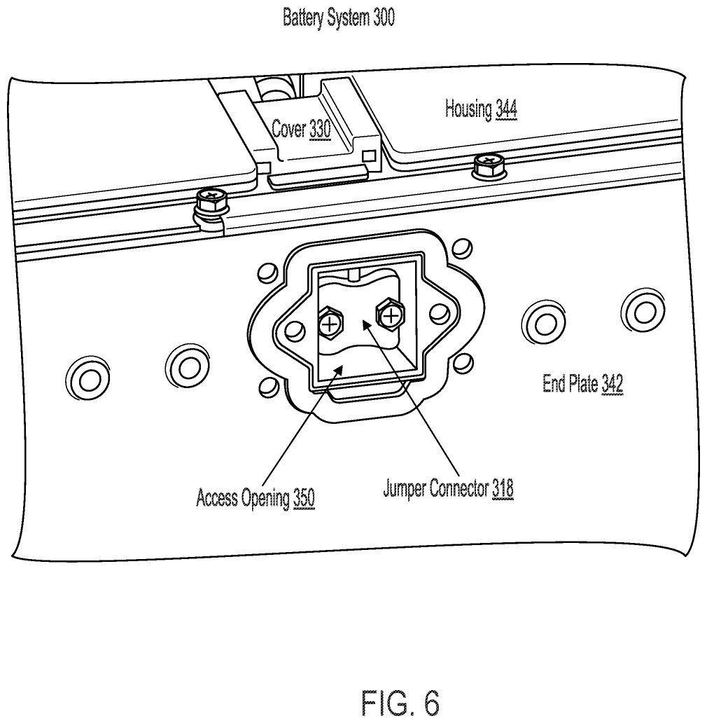

FIG. 6 illustrates an example of an access opening for accessing the busbar for reducing the voltage of a battery pack 110. Access opening 350 can include an opening, through-hole, or passage through the end plate 342, or any other portion of housing 344, to view, access, reach into and work on the jumper connector 318 of the busbar 310. Access opening 350 can expose for the user screws or fasteners used to couple the jumper connector 318 to the jumpers 314 and/or bodies 312 of the busbar 310.

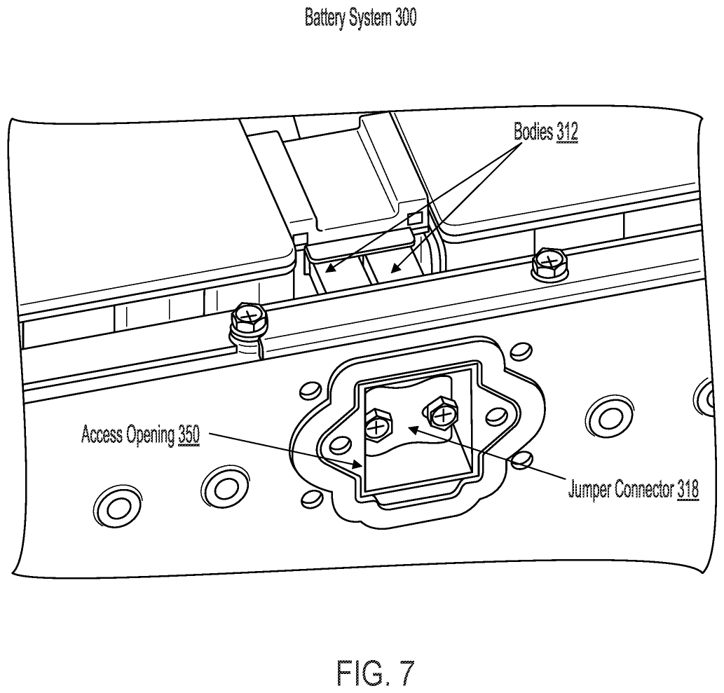

FIG. 7 illustrates an example of a top view of the access opening and the busbar in a battery pack. As shown in FIG. 7, bodies 312 of the busbar 310 can be accessed by removing the cover 330 on the top surface of the battery pack 110. Upon removal of the cover 330, user can access screws or fasteners coupling the interior ending of the body 312 with the portions of the battery pack 110 (e.g., group of battery cells 120) to which each of the bodies 312 is connected. Accessing the jumper connector 318 through the access opening 350 however, allows the user to decouple the bodies 312 from each other (e.g., thereby reducing the battery pack voltage and current) without removing the cover 330 or removing the battery pack 110 from the EV 105. Access opening 350 therefore can allow the user to remove the jumper connector 318 and decouple sections of the battery pack 110 coupled with different bodies 312 without removing the battery pack 110 or the subassemblies 115.

In some aspects, the present solution is directed to a battery system 300. The battery system 300 can include a busbar 310 to electrically couple with a battery pack 110. The busbar 310 can electrically couple between and with two groups of battery cells 120 of the battery pack 110. For example, the busbar 310 can include a first body 312 that is electrically coupled with a first group of battery cells 120 of the two groups of battery cells 120 and a second body 312 that is electrically coupled with a second group of battery cells 120 of the two groups of battery cells 120. The battery system 300 can include the busbar 310 to dispose at an opening of a housing 344 of the battery pack 110. The busbar 310 can be exposed by an access cover 340. For example, an access cover 340 can obscure or cover an access opening 350 configured to allow a user (e.g., technician or a mechanic) to attach a jumper connector 318 to the bodies 312 of the busbar 310, thereby electrically coupling the bodies 312 and their respective groups of battery cells 120. Similarly, access opening 350 can allow a user (e.g., technician or a mechanic) to remove a jumper connector 318 from the bodies 312 of the busbar 310, thereby electrically decoupling the bodies 312 and their respective groups of battery cells 120.

The battery system 300 can include the busbar 310 to include one or more bodies 312. Each of the bodies 312 can be electrically coupled with one or more jumpers 314. A jumper 314 can include an electrically conductive (e.g., metal) component. Jumper 314 can be shaped, formed, or configured to provide a tight physical and electrical connection with jumper connector 318 and/or body 312. Jumper 314 can be an integral component or part (e.g., an end) of the body 312. Jumper 314 can be bent relative to the body 312. For example, jumper 314 can be bent at 90 degrees with respect to the body (e.g., form a right angle with the body 312). The jumper 314 can be located within the housing 344 and can be exposed (e.g., for inspection, troubleshooting, fixing or adjustment) by removal of the access cover 340.

The battery system 300 can include the busbar 310 that includes a body 312 and a jumper 314. For example, a busbar 310 can include one or more bodies 312. Each of the bodies 312 can be electrically insulated from other bodies 312 of the busbar 310, except via jumper connector 318. The jumper connector 318 can electrically couple the bodies 312 of the busbar 310 into a single electrically conductive component. A cover 330 can include an electrically insulating material and can be disposed above one or more bodies 312. Cover 330 can cover a portion of the body 312, or an entire body 312.

The battery system 300 can include the busbar 310 that can couple with the battery pack 110 at a middle location between the two groups of battery cells 120. For example, the busbar 310 can be located on or near a surface (e.g., top or bottom surface) of the battery pack 110. Busbar 310 can include a first body 312 that is electrically coupled with one half of the battery cells 120 (e.g., a left side of the battery pack 110 having one or more battery subassemblies 115 filled with battery cells 120). Busbar 310 can include a second body 312 that is electrically coupled with a second half of the battery cells 120 (e.g., a right side of the battery pack 110 having one or more battery subassemblies 115 filled with battery cells 120). In doing so, the busbar 310 can allow the battery cells 120 of both halves of the battery pack 110 to be connected to each other (e.g., in series to provide a maximum voltage) via a jumper connector 318. Once a jumper connector 318 is removed, the two halves of the battery pack 110 can provide a half of their maximum voltage output when they were connected via the jumper connector 318.

The battery system 300 can include a first body 312 of the busbar 310 electrically coupled with a first group of the two groups of battery cells 120 and a second body 312 of the busbar 312 electrically coupled with a second group of the two groups of battery cells 120. The first group of battery cells 120 can include a half of battery cells 120 of the battery pack 110 (e.g., when busbar 310 includes two bodies 312), a third of the battery cells 120 of the battery pack 110 (e.g., when busbar 310 includes three bodies 312), a quarter of the battery cells 120 (e.g., when busbar 310 includes four bodies 312) and so on. Remaining bodies 312, such as the second body 312, can be connected to the second group of the battery cells 120. For example, a third body 312 can be connected to a third group of the battery cells 120. For example, a fourth body 312 can be connected to a fourth group of the battery cells 120.

The battery system 300 can include the busbar 310 to dispose at an end plate 342 of the housing 344. The busbar 310 can be disposed near an end plate 342 of the housing 344. For example, the jumper connector 318 can be disposed next to or within the end plate 342. For example, jumper connector 318 of the busbar 310 can be disposed, located, formed, or placed within the access opening 350 that is within the end plate 342. Jumper connector 318 of the busbar 310 and the busbar 310 can be positioned next to, adjacent to, abutting or otherwise running by the plate 342 or any surface of housing 344 (e.g., top side or surface of the housing 344, bottom side or surface of the housing 344, any of the side surfaces of the housing 344, front or the back surfaces of the housing 344).

The battery system 300 can include a jumper connector 318 electrically coupling a first body 312 of the busbar 310 with the second body 312 of the busbar 310. The jumper connector 318 can be removable via an access opening 350 of the access cover 340 on an end plate of the housing 344. Removing the jumper connector 318 can cause a first group of the two groups of battery cells 120 to electrically decouple from a second group of the two groups of the battery cells 120. For example, when busbar 312 includes more than two bodies 312, each of the groups of battery cells 120 coupled with each of the bodies 312 can be electrically decoupled by removing the jumper connector 318 and electrically coupled by placing, installing, or connecting the jumper connector 318 back with the bodies 312 (e.g., or jumpers 314).

The battery system 300 can include a jumper connector 318 electrically coupling a first jumper 314 of a first body 312 of the busbar 310 coupled with a first group of the two groups of the battery cells 120 with a second jumper 314 of a second body 312 of the busbar 310 coupled with a second group of the two groups of the battery cells 312. The jumper connector 318 can be configured to electrically decouple a first group of the two groups of the battery cells 120 from a second group of the two groups of the battery cells 120 by removing the jumper connector 318 from a jumper 314 of a body 312 of the busbar 310.

The battery system 300 can include a second busbar 310 to electrically couple the battery pack 110 with a second battery pack 110. The battery system 300 can include a second jumper connector 318 electrically coupling a first jumper 314 of a first body 312 of the second busbar 310 coupled with the battery pack 110 with a second jumper 314 of a second body 312 of the second busbar 310 coupled with the second battery pack 110. For example, the jumper connector 318 can electrically couple any number of bodies 312 coupled with their respective groups of battery cells 120 via their respective jumpers 314. The battery system 300 can include a second jumper connector 318 configured to electrically decouple the battery pack 110 from the second battery pack 110 by removing the second jumper connector 318 from a jumper 314 of a body 312 of the second busbar 310 via an access opening 350.

In some aspects, the present solution relates to a battery system 300 of an electric vehicle 105. The battery system 300 can include a busbar 310 to electrically couple with a battery pack 110 between two groups of battery cells of the battery pack 110. The busbar 310 can be disposed at an opening of a housing 344 of the battery pack 110. The busbar 310 can be exposed by an access cover 340. The battery system can include a jumper connector 318 to electrically couple a first body 312 of the busbar 310 with the second body 312 of the busbar 310. The jumper connector 318 can be removable via the access cover 340 on an end plate of the housing 344 to cause a first group of the two groups of battery cells 120 electrically coupled with the first body to electrically decouple from a second group of the two groups of the battery cells 120 electrically coupled with the second body.

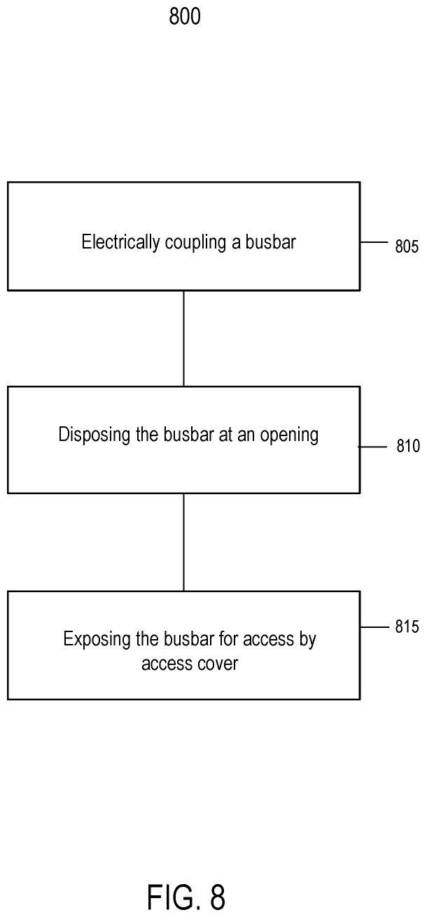

FIG. 8 depicts a method 800 for providing a busbar of a battery pack for access for electrical decoupling of at least a portion of a battery pack via the busbar. The method 800 can also be directed to reducing the voltage of a battery pack using a busbar of the battery pack or electrically decoupling at least a portion of a battery pack. The method 800 can be implemented, for example, using components or features of battery system 300 discussed in FIGS. 3-7. At ACT 805, the method can include electrically coupling a busbar. At ACT 810, the method can include disposing the busbar at an opening. At ACT 815, the method can include exposing the busbar for access by an access cover.

At ACT 805, the method can include electrically coupling a busbar. The method can include electrically coupling a busbar with two groups of battery cells of a battery pack. For example, the busbar can be formed to include a body of the busbar and a jumper of the busbar. The jumper of the busbar can be formed, shaped, or configured to be bent relative to the body of the busbar. The jumper and the body can be located within the housing of the battery pack. The jumper and the body can be formed to comprise electrically conductive material (e.g., metal) and can include a single structure or component or multiple structures or components. The jumper can be formed, configured, or shaped to provide a flush surface physical and electrical contact with the jumper connector.

The method can include providing a first body of the busbar electrically coupled with a first group of the two groups of battery cells. The first body can include an electrically conductive rod, wire, or a bar, as well as one or more components, which can be in electrical continuity with a group of battery cells. The group of battery cells can include the battery cells of one or more battery subassemblies. The group of battery cells can include the battery cells within a single battery subassembly. The group of battery cells can include, for example, a half of battery cells of the battery pack, a third of battery cells of the battery pack, a quarter of battery cells of the battery pack, or any other fraction of battery cells, such as ⅕, ⅙, 1/7, ⅛, 1/9, 1/10, 1/16 or less than 1/16 of the battery cells. Each of the groups of battery cells can be coupled to its own body of the busbar.

The method can include providing a second body of the busbar electrically coupled with a second group of the two groups of battery cells. The second body of the busbar can be electrically insulated from the first body of the busbar, except for the electrical contact via the jumper connector. The second body of the busbar can be spaced apart from the first body of the busbar. For example, in configurations in which more than two bodies are included, all bodies of the busbar can be spaced apart from each other. The second body of the busbar can be electrically coupled with the second group of battery cells, which can include any amount or fraction of battery cells of the battery pack, such as one half, one third, one quarter, ⅕, ⅙, 1/7, ⅛, 1/9, 1/10, 1/16 or less than 1/16 of the battery cells.

The method can include providing a first body of the busbar having a first jumper exposed for access via the access cover. The method can include providing a second body of the busbar having a second jumper exposed for access via the access cover. A jumper connector of the busbar can electrically couple the first body via the first jumper with the second body via the second jumper. Coupling of the first body and the second body via the jumper connector can cause a first group of the two groups of battery cells electrically coupled with the first body to electrically couple with a second group of the two groups of the battery cells electrically coupled with the second body. The jumper connector can removable via the access cover on an end plate of the housing. The jumper connector can be removable by removing fasteners or screws coupling the jumper connector with the jumpers or bodies of the busbar.

At ACT 810, the method can include disposing the busbar at an opening. The method can include disposing the busbar at an opening of a housing of the battery pack. The busbar can be disposed at an opening in an end plate, front plate, side plate, top plate or bottom plate or surface of the housing. The busbar can be disposed to have its end (e.g., jumper connector side of the busbar) accessible to a user (e.g., a mechanic or a technician) via the opening. The method can include providing the busbar having a body electrically coupled with a jumper. For example, the jumper and the busbar can be integrated or formed into a single structure or a component, or they can include multiple structures electrically coupled with each other.

The method can include providing a cover disposed to cover a portion of the body. The cover can be formed using an electrically insulating material, such as plastic. The cover can be removable so to provide access to the portion of the body of the busbar. The cover can be integrated with or coupled with the housing or a plate of the battery pack (e.g., end plate or top plate). The method can include electrically coupling the busbar with the battery pack at a middle location between the two groups of battery cells. For example, the busbar can be disposed down the middle portion of the battery pack, so that a first body of the busbar on the left side of the battery pack can be coupled with the battery cells at the left side of the battery pack and the second body of the busbar on the right side of the battery pack can be coupled with the battery cells on the right side of the battery pack. The method can include disposing the busbar for access via an access opening of the access cover at an end plate of the housing.

At ACT 815, the method can include exposing the busbar for access by or via an access cover. The method can include exposing the busbar for access by an access cover via the opening. For example, the busbar can be exposed for access by a user (e.g., technician or a mechanic) via the opening from which the cover can be removed. The method can include exposing the jumper of the busbar by removal of the access cover. For example, the cover can be removed to expose the jumper side of the bodies of the busbar. An access cover can cover the access opening and can be movable, slidable or removable from the access opening to expose the jumper connector at an end of the busbar.

The method can include providing a jumper connector electrically coupling a first jumper of a first body of the busbar coupled with a first group of the two groups of the battery cells with a second jumper of a second body of the busbar coupled with a second group of the two groups of the battery cells. For example, the jumper connector can be provided or exposed for access by a user via the access opening to allow the user to electrically decouple the bodies of the busbar from each other by removing the jumper connector. The jumper connector can be configured to electrically decouple the first group of the two groups of the battery cells from the second group of the two groups of the battery cells by removing the jumper connector via an access opening of the access cover.

The method can include electrically coupling, by a second busbar, the battery pack with a second battery pack. For example, the second busbar can be provided to couple one battery pack having a plurality of battery subassemblies and/or battery cells with another battery pack having a plurality of battery subassemblies and/or battery cells. The second busbar can include same or similar structural and functional features as the busbar. The second busbar can include a second jumper connector electrically coupling a first jumper of a first body of the second busbar coupled with the battery pack with a second jumper of a second body of the second busbar coupled with the second battery pack. The second jumper connector can be configured to electrically decouple the battery pack from the second battery pack by removing the second jumper connector from a jumper of a body of the second busbar.

The systems described above can provide multiple ones of any or each of those components and these components can be provided on either a standalone system or on multiple instantiation in a distributed system.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, positive or negative polarity of battery cells 120, battery subassemblies 115 or battery packs 110 can be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a busbar to electrically couple with a battery pack between two groups of battery cells of the battery pack, the busbar to dispose at an opening of a housing of the battery pack, wherein the busbar is to be exposed by an access cover.

2. The system of claim 1, wherein the system comprises the busbar to include a body and a jumper, the jumper is bent relative to the body, the jumper to be located within the housing and be exposed by removal of the access cover.

3. The system of claim 1, wherein the system comprises the busbar to include a body and a jumper, a cover disposed to cover a portion of the body.

4. The system of claim 1, wherein the system comprises the busbar to couple with the battery pack at a middle location between the two groups of battery cells.

5. The system of claim 1, wherein the system comprises a first body of the busbar electrically coupled with a first group of the two groups of battery cells and a second body of the busbar electrically coupled with a second group of the two groups of battery cells.

6. The system of claim 1, wherein the system comprises the busbar to dispose at an end plate of the housing.

7. The system of claim 1, wherein the system comprises a jumper connector electrically coupling a first body of the busbar with the second body of the busbar, the jumper connector removable via an access opening of the access cover on an end plate of the housing to cause a first group of the two groups of battery cells to electrically decouple from a second group of the two groups of the battery cells.

8. The system of claim 1, wherein the system comprises a jumper connector electrically coupling a first jumper of a first body of the busbar coupled with a first group of the two groups of the battery cells with a second jumper of a second body of the busbar coupled with a second group of the two groups of the battery cells.

9. The system of claim 1, wherein the system comprises a jumper connector configured to electrically decouple a first group of the two groups of the battery cells from a second group of the two groups of the battery cells by removing the jumper connector from a jumper of a body of the busbar.

10. The system of claim 1, wherein the system comprises a second busbar to electrically couple the battery pack with a second battery pack.

11. The system of claim 10, wherein the system comprises a second jumper connector electrically coupling a first jumper of a first body of the second busbar coupled with the battery pack with a second jumper of a second body of the second busbar coupled with the second battery pack.

12. The system of claim 10, wherein the system comprises a second jumper connector configured to electrically decouple the battery pack from the second battery pack by removing the second jumper connector from a jumper of a body of the second busbar via an access opening.

13. A method for electrically decoupling at least a portion of a battery pack, comprising:
electrically coupling a busbar with two groups of battery cells of a battery pack;
disposing the busbar at an opening of a housing of the battery pack; and
exposing the busbar for access by an access cover via the opening.

14. The method of claim 13, comprising:
forming the busbar to include a body of the busbar and a jumper of the busbar bent relative to the body, the jumper to be located within the housing; and
exposing the jumper of the busbar by removal of the access cover.

15. The method of claim 13, comprising:
providing the busbar having a body electrically coupled with a jumper;
providing a cover disposed to cover a portion of the body; and
electrically coupling the busbar with the battery pack at a middle location between the two groups of battery cells.

16. The method of claim 13, comprising:
providing a first body of the busbar electrically coupled with a first group of the two groups of battery cells;
providing a second body of the busbar electrically coupled with a second group of the two groups of battery cells; and
disposing the busbar for access via an access opening of the access cover at an end plate of the housing.

17. The method of claim 13, comprising:
providing a first body of the busbar having a first jumper exposed for access via the access cover;
providing a second body of the busbar having a second jumper exposed for access via the access cover;
electrically coupling, by a jumper connector, the first body via the first jumper with the second body via the second jumper to cause a first group of the two groups of battery cells electrically coupled with the first body to electrically couple with a second group of the two groups of the battery cells electrically coupled with the second body, the jumper connector removable via the access cover on an end plate of the housing.

18. The method of claim 13, comprising:
providing a jumper connector electrically coupling a first jumper of a first body of the busbar coupled with a first group of the two groups of the battery cells with a second jumper of a second body of the busbar coupled with a second group of the two groups of the battery cells, wherein the jumper connector is configured to electrically decouple the first group of the two groups of the battery cells from the second group of the two groups of the battery cells by removing the jumper connector via an access opening of the access cover.

19. The method of claim 13, comprising:
electrically coupling, by a second busbar, the battery pack with a second battery pack;
electrically coupling, by a second jumper connector, a first jumper of a first body of the second busbar coupled with the battery pack with a second jumper of a second body of the second busbar coupled with the second battery pack, wherein the second jumper connector is configured to electrically decouple the battery pack from the second battery pack by removing the second jumper connector from a jumper of a body of the second busbar.

20. A battery system of an electric vehicle, the battery system comprising:
a busbar to electrically couple with a battery pack between two groups of battery cells of the battery pack, the busbar to dispose at an opening of a housing of the battery pack, wherein the busbar is to be exposed by an access cover; and
a jumper connector to electrically couple a first body of the busbar with the second body of the busbar, the jumper connector removable via the access cover on an end plate of the housing to cause a first group of the two groups of battery cells electrically coupled with the first body to electrically decouple from a second group of the two groups of the battery cells electrically coupled with the second body.
